(19) United States
(12) Patent Application Publication
(10) Pub. No.: US 2025/0160246 A1
(43) Pub. Date: May 22, 2025

(54) SELF-PROPELLED ROBOTIC LAWNMOWER

(71) Applicant: HUSQVARNA AB, Huskvarna (SE)

(72) Inventors: Mats SVENSSON, Huskvarna (SE); Johan BENGTZOHN, Huskvarna (SE); Jonas ELDERSTIERN, Huskva (SE); Christopher CUNNINGHAM, Huskvarna (SE); Tom ADKINS, Huskvarna (SE)

(21) Appl. No.: 18/947,341

(22) Filed: Nov. 14, 2024

(30) Foreign Application Priority Data
Nov. 17, 2023 (SE) 2351316-1

(51) Int. Cl. A01D 34/00; A01D 34/78; A01D 34/82; A01D 69/02; A01D 75/18; A01D 101/00

(52) U.S. Cl. CPC A01D 34/008; A01D 34/78; A01D 34/828; A01D 69/02; A01D 75/185; A01D 2101/00

(57) ABSTRACT

A self-propelled robotic lawnmower is disclosed comprising a number of lawnmower support members configured to abut against a ground surface in a first plane during operation of the robotic lawnmower, a cutting unit, and an external guard enclosing at least part of the cutting unit. The external guard comprises an edge portion facing the first plane and a bumper section extending along at least a portion of the edge portion. The bumper section protrudes out from the external guard and has a radius of curvature within the range of 5-40 mm.

### TECHNICAL FIELD

The present disclosure relates to a self-propelled robotic lawnmower comprising a cutting unit and an external guard enclosing at least part of the cutting unit.

### BACKGROUND

A self-propelled robotic lawnmower is an apparatus capable of cutting grass autonomously, i.e., without the direct intervention of a human, in various areas. Some robotic lawnmowers require a user to set up a border wire around a lawn that defines the area to be mowed. These lawnmowers use a sensor to locate the wire and thereby the boundary of the mowing area. In addition to the wire, robotic lawnmowers may also comprise other types of positioning units and sensors, for example sensors for detecting an event, such as a collision with an object within the area. The robotic lawnmower may move in a systematic and/or random pattern to ensure that the area is completely cut.

A robotic lawnmower usually comprises one or more batteries and one or more electrically driven cutting units being powered by the one or more batteries. In some cases, the robotic lawnmower uses the wire to locate a recharging dock used to recharge the one or more batteries. Generally, robotic lawnmowers operate unattended within the area in which they operate. Examples of such areas are lawns, gardens, parks, sports fields, golf courts and the like.

Self-propelled robotic lawnmowers of various types are associated with some mutual problems. One such problem is the energy consumption of the robotic lawnmower. Cutting grass usually requires a significant amount of energy. Due to environmental concerns, it is a great advantage if lawnmowers and associated arrangements and systems can be arranged to operate in an energy-efficient manner.

Moreover, after a certain time of operation, an energy storage unit of a lawnmower, such as a battery or fuel tank, has to be charged or refilled. Thus, by reducing the energy consumption of the robotic lawnmower, more available operational time of the robotic lawnmower can be obtained given a certain energy storing capacity of the energy storage unit of the robotic lawnmower. Furthermore, a more cost-efficient lawnmower can be provided by reducing the energy consumption of the robotic lawnmower because the consumption of fuel or electricity incurs costs.

Another problem associated with robotic lawnmowers is false collision detection signals from a collision detection system of the robotic lawnmower. That is, most robotic lawnmowers comprise a collision detection system which may comprise one or more sensors arranged to detect occurrences of impacts between the robotic lawnmower and external objects. Moreover, a control arrangement of the robotic lawnmower is usually configured to stop movement of the robotic lawnmower when the collision detection system is detecting an impact between the robotic lawnmower and an external object, and then initiate movement in another direction, such as in a reverse direction of the robotic lawnmower.

In some geographical areas, lawns are generally cut at a higher height due to warm climate, cultural habits, and desired visual appearance. Popular choices, such as tall fescue grass, are cold season grasses but are widely used in transition zones for their aesthetic appeal. The grass height for mowed grass is usually between 75-125 mm, but the grass height can in tough situations be up to 150 to 200 mm before mowing the grass.

When the robotic lawnmower moves in areas with such tall grass, the force on the main body of the robotic lawnmower can become very high which increases the risk of having false collision detection signals from the collision detection system of the robotic lawnmower, mistakenly interpreting the grass as an obstacle. As a result, the robotic lawnmower might engage in inefficient back-and-forth movements, and some areas may be left uncut. Additionally, moving through tall grass can be challenging for the mower. The tall grass increases friction, forcing the wheel motors to work harder. This extra effort can lead to more frequent slipping of the drive wheels and obviously increases the energy consumption of the robotic lawnmower.

### SUMMARY

It is an object of the present invention to overcome, or at least alleviate, at least some of the above-mentioned problems and drawbacks. The object is achieved by the subject-matter of the appended independent claim(s).

According to a first aspect of the present disclosure, the object is achieved by a self-propelled robotic lawnmower comprising a number of lawnmower support members configured to abut against a ground surface in a first plane during operation of the robotic lawnmower, a cutting unit, and an external guard enclosing at least part of the cutting unit. The external guard comprises an edge portion facing the first plane and a bumper section extending along at least a portion of the edge portion. The bumper section protrudes out from the external guard and has a radius of curvature within the range of 5
40 mm.

Thereby, a robotic lawnmower is provided having conditions for reduced friction between the external guard and grass moving towards the external guard. This is because the external guard comprises the bumper section extending along at least a portion of the edge portion and since the bumper section protrudes out from the external guard and has a radius of curvature within the range of 5-40 mm.

That is, the fact that the bumper section extends along at least a portion of the edge portion, and the bumper section protrudes out from the external guard and has a radius of curvature within the range of 5-40 mm, ensures low frictional properties between the external guard and grass partially because the grass can be bent in a smoother manner upon reaching the edge portion of the external guard.

Since conditions are provided for reduced friction between the external guard of the robotic lawnmower and grass, a robotic lawnmower is provided having conditions for a reduced energy consumption. As a further result, conditions are provided for an increased available operational time of the robotic lawnmower before an energy storing unit of the robotic lawnmower has to be charged or refilled. Moreover, the robotic lawnmower can be operated in a more cost-efficient and environmentally friendly manner.

In addition, since conditions are provided for reduced friction between the external guard of the robotic lawnmower and grass, the robotic lawnmower has conditions for operating areas having considerable grass heights, such as a grass height exceeding 130 mm, with a lowered risk of obtaining false collision detection signals from a collision detection system of the robotic lawnmower. Moreover, a robotic lawnmower is provided having a lowered risk of slipping of drive wheels while navigating through such areas.

Accordingly, a robotic lawnmower is provided overcoming, or at least alleviating, at least some of the above-mentioned problems and drawbacks. As a result, the above-mentioned object is achieved.

According to the embodiments herein, the robotic lawnmower is a small or mid-sized robotic lawnmower configured to be used to cut grass in areas used for aesthetic and recreational purposes, such as gardens, parks, city parks, sports fields, lawns around houses, apartments, commercial buildings, offices, and the like.

Optionally, the bumper section has a radius of curvature within the range of 5-40 mm as measured in a second plane, and wherein the second plane is perpendicular to the first plane and is parallel to a surface normal of the external guard at an intersection between the second plane and the external guard. Thereby, reduced friction between the external guard and grass can be further ensured.

Optionally, the bumper section has a radius of curvature within the range of 5-40 mm at a first portion of the bumper section, and wherein the first portion points in a direction parallel to the first plane. Since the bumper section has a radius of curvature within the range of 5-40 mm at a portion of the bumper section pointing in a direction parallel to the first plane, a low friction between the external guard and grass can be further ensured upon movement of the robotic lawnmower in directions parallel to the first plane, i.e., in directions parallel to the ground surface. This is because grass is likely to first abut against the first portion of the bumper section when the robotic lawnmower is moving over a ground surface.

The first portion of the bumper section, as referred to herein, may also be referred to as a longitudinal or lateral end portion of the bumper section.

Optionally, the bumper section has a radius of curvature within the range of 5-40 mm at a second portion of the bumper section, and wherein the second portion points in a direction towards the first plane. Since the bumper section has a radius of curvature within the range of 5-40 mm at a portion of the bumper section pointing in a direction towards the first plane, a low friction between the external guard and grass can be further ensured upon movement of the robotic lawnmower in directions parallel to the first plane, i.e., in directions parallel to the ground surface. This is because grass is likely to abut against the second portion of the bumper section when the robotic lawnmower is moving over a ground surface after first having been bent by a longitudinal or lateral end portion of the bumper section.

The second portion of the bumper section, as referred to herein, may also be referred to as a vertical end portion of the bumper section.

Optionally, the bumper section has a radius of curvature within the range of 5-40 mm along the full extension between the first and second portions. Thereby, low friction between the external guard and grass can be further ensured upon movement of the robotic lawnmower in directions parallel to the first plane, i.e., in directions parallel to the ground surface. This is because grass reaching the bumper section can be bent in a smooth manner upon movement of the robotic lawnmower in directions parallel to the ground surface.

Optionally, the distance between the first plane and a second portion of the bumper section, pointing in a direction towards the first plane, is within the range of 60-80 mm, or is within the range of 65-75 mm. Thereby, a low resistance force can be ensured between the external guard and grass of a lawn while providing conditions for efficiently preventing a limb of a person or animal from reaching the cutting unit of the robotic lawnmower.

Optionally, the bumper section has a radius of curvature within the range of 5-40 mm along more than 50% of the circumference of the bumper section. Thereby, low friction between the external guard and grass can be ensured upon movement of the robotic lawnmower over a lawn having a considerable grass height.

Optionally, the bumper section extends along a front portion of the edge portion as seen relative to a forward moving direction of the robotic lawnmower. Thereby, low friction between the external guard and grass can be ensured upon movement of the robotic lawnmower in a forward moving direction of the robotic lawnmower over a ground surface.

Optionally, the bumper section extends along a lateral side portion of the edge portion as seen relative to a forward moving direction of the robotic lawnmower.

Thereby, low friction between the external guard and grass can be ensured upon movement of the robotic lawnmower in an at least partially lateral moving direction over a ground surface, such as when the robotic lawnmower is turning.

Optionally, at least a first part of the bumper section is formed by a curved portion of the external guard. Thereby, conditions are provided for a robust external guard having conditions for reducing friction between the external guard and grass upon movement of the robotic lawnmower over a lawn in an efficient manner.

Optionally, the bumper section comprises a second part attached to the first part. Thereby, a robotic lawnmower is provided having conditions and characteristics suitable for being manufactured in a simple and cost-efficient manner, while having conditions for reducing friction between the external guard and grass upon movement of the robotic lawnmower over a lawn.

Optionally, the first part is arranged closer to the first plane than the second part. Thereby, conditions are provided for a robust external guard having conditions for reducing friction between the external guard and grass in an efficient manner upon movement of the robotic lawnmower over a lawn.

Optionally, the first and second parts together form a hollow structure. Thereby, conditions are provided for an external guard having a low weight, while being robust.

Optionally, bumper section only protrudes in directions out from a volume enclosed by the external guard. Thereby, conditions are provided for a robotic lawnmower capable of reducing friction between the external guard and grass upon movement of the robotic lawnmower over a lawn while not imparting on the volume inside the external guard.

Optionally, the robotic lawnmower comprises a control arrangement configured to navigate the robotic lawnmower over the ground surface.

Optionally, the robotic lawnmower comprises a sensor assembly configured to detect occurrences of impacts between the robotic lawnmower and external objects, and wherein the control arrangement is configured to stop movement of the robotic lawnmower when the sensor assembly is detecting an impact between the robotic lawnmower and an external object. Since the external guard of the robotic lawnmower is capable of reducing friction against grass, a robotic lawnmower is provided having conditions for a reduced likelihood of obtaining false collision detection signals from the sensor assembly, for example when the robotic lawnmower is moving into areas having considerable grass heights, such as having a grass height exceeding 130 mm.

Further features of, and advantages with, the present invention will become apparent when studying the appended claims and the following detailed description.

### BRIEF DESCRIPTION OF THE DRAWINGS

Various aspects of the present disclosure, including its particular features and advantages, will be readily understood from the example embodiments discussed in the following detailed description and the accompanying drawings, in which:

FIG. 1 illustrates a perspective view of a self-propelled robotic lawnmower according to some embodiments of the present disclosure,

FIG. 2 illustrates a side view of the robotic lawnmower illustrated in FIG. 1,

FIG. 3 illustrates a cross section of the robotic lawnmower illustrated in FIG. 1 and FIG. 2,

FIG. 4 illustrates a top view of the robotic lawnmower illustrated in FIG. 1-FIG. 3,

FIG. 5 illustrates an enlarged portion of the cross section of FIG. 3, and

FIG. 6 illustrates the cross section of FIG. 5 in which the robotic lawnmower has moved a distance in a forward moving direction from the position illustrated in FIG. 5.

### DETAILED DESCRIPTION

Aspects of the present disclosure will now be described more fully. Like reference signs refer to like elements throughout. Well-known functions or constructions will not necessarily be described in detail for brevity and/or clarity.

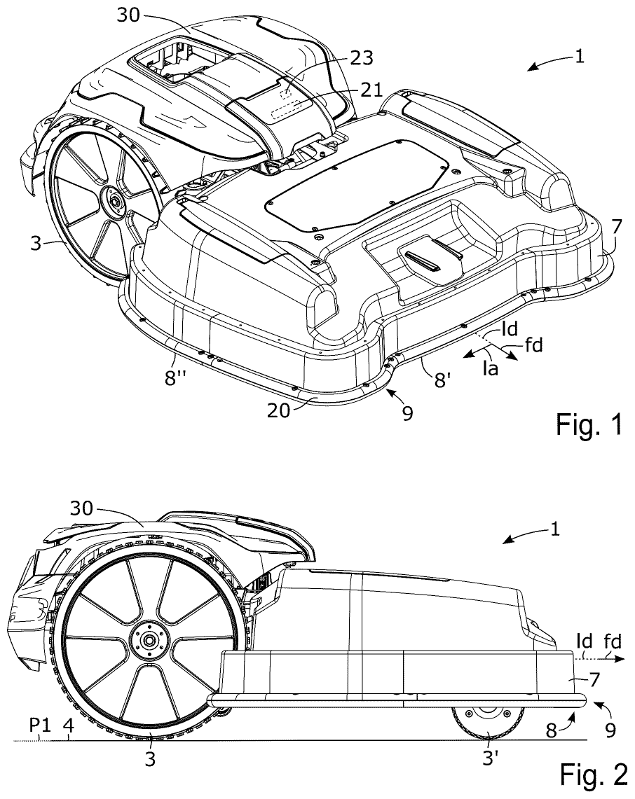

FIG. 1 illustrates a perspective view of a self-propelled robotic lawnmower 1 according to some embodiments of the present disclosure. The feature that the robotic lawnmower 1 is self-propelled means that the robotic lawnmower 1 is capable of navigating and operating an area in an autonomous manner, i.e., in a manner not requiring the direct intervention or control of a user.

For reasons of brevity and clarity, the self-propelled autonomous robotic lawnmower 1 is in some places herein simply referred to as “the robotic lawnmower 1”. According to the embodiments herein, the robotic lawnmower 1 is a small or mid-sized robotic lawnmower 1 configured to be used to cut grass in areas used for aesthetic and recreational purposes, such as gardens, parks, city parks, sports fields, lawns around houses, apartments, commercial buildings, offices, and the like.

FIG. 2 illustrates a side view of the robotic lawnmower 1 illustrated in FIG. 1. In FIG. 2, the robotic lawnmower 1 is illustrated as positioned in an intended use position on a flat ground surface 4. Below, simultaneous reference is made to FIG. 1 and FIG. 2, if not indicated otherwise.

The robotic lawnmower 1 comprises lawnmower body 30 and a number of lawnmower support members 3, 3′ configured to abut against a ground surface 4 in a first plane P1 during operation of the robotic lawnmower 1 to support the lawnmower body 30. Accordingly, the first plane P1 will extend along a ground surface 4 when the robotic lawnmower 1 is positioned on a flat ground surface 4 in an intended use position thereon as is illustrated in FIG. 2. Moreover, the first plane P1 will adjoin ground engaging portions of the number of lawnmower support members 3, 3′ when the robotic lawnmower 1 is positioned on a flat ground surface 4 in an intended use position thereon as is illustrated in FIG. 2.

In FIG. 1 and FIG. 2, a longitudinal direction 1d of the robotic lawnmower 1 is indicated. The longitudinal direction 1d of the robotic lawnmower 1 extends in a lateral/longitudinal plane of the robotic lawnmower 1. The lateral/longitudinal plane is parallel to the first plane P1. The longitudinal direction 1d of the robotic lawnmower 1 is thus parallel to the first plane P1 and thus also to a ground surface 4 when the robotic lawnmower 1 is positioned onto a flat ground surface 4 in an intended use position.

Moreover, the longitudinal direction 1d of the robotic lawnmower 1 is parallel to a forward direction fd of the robotic lawnmower 1 as well as a reverse direction of the robotic lawnmower 1. The reverse direction is opposite to the forward direction fd. The forward direction fd of the robotic lawnmower 1 may also be referred to as a forward moving direction fd of the robotic lawnmower 1. Likewise, the reverse direction of the robotic lawnmower 1 may also be referred to as a reverse moving direction of the robotic lawnmower 1.

Moreover, in FIG. 1, a lateral direction 1a of the robotic lawnmower 1 is indicated. The lateral direction 1a of the robotic lawnmower 1 is parallel to the lateral/longitudinal plane of the robotic lawnmower 1 referred to above and is perpendicular to each of the forward moving direction fd of the robotic lawnmower 1 and the reverse moving direction of the robotic lawnmower 1. Accordingly, the lateral direction 1a of the robotic lawnmower 1 is parallel to the first plane P1 and thus also to a ground surface 4 when the robotic lawnmower 1 is positioned onto the flat ground surface 4 in the intended use position.

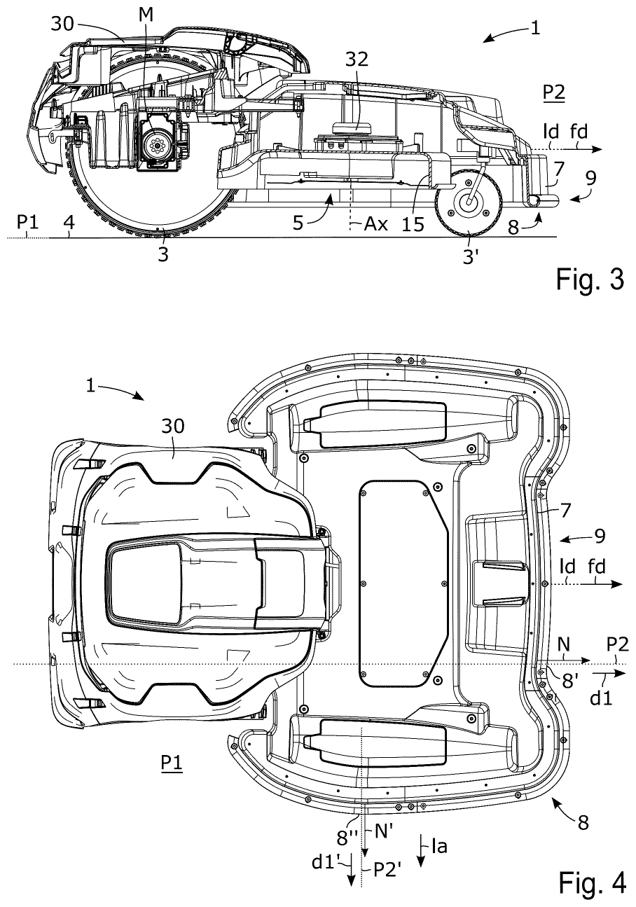

FIG. 3 illustrates a cross section of the robotic lawnmower 1 illustrated in FIG. 1 and FIG. 2. In FIG. 3, the cross section is made in a second plane P2. In FIG. 3, the second plane P2 is perpendicular to the first plane P1 and is parallel to the longitudinal direction 1d of the robotic lawnmower 1. Below, simultaneous reference is made to FIG. 1 and FIG. 2, if not indicated otherwise.

As is best seen in FIG. 3, according to the illustrated embodiments, the lawnmower support members 3, 3′ is wheels 3, 3′ of the robotic lawnmower 1. Moreover, according to the illustrated embodiments, the robotic lawnmower 1 comprises four wheels 3, 3′, namely two drive wheels 3 and two support wheels 3′. The drive wheels 3 of the robotic lawnmower 1 may each be powered by an electrical motor M of the robotic lawnmower 1 to provide motive power and/or steering of the robotic lawnmower 1.

According to the illustrated embodiments, the drive wheels 3 of the robotic lawnmower 1 are non-steered wheels having a fix rolling direction in relation to the lawnmower body 30. The respective rolling direction of the drive wheels 3 of the robotic lawnmower 1 is substantially parallel to the longitudinal direction 1d of the robotic lawnmower 1. According to the illustrated embodiments, the support wheels 3′ are non-driven wheels. Moreover, according to the illustrated embodiments, the support wheels 3′ are pivotally arranged around a respective pivot axis such that the rolling direction of the respective support wheel 3′ can follow a travel direction of the robotic lawnmower 1.

As understood from the above, when the drive wheels 3 of the robotic lawnmower 1 are rotated at the same rotational velocity in a forward rotational direction, and no wheel slip is occurring, the robotic lawnmower 1 will move in the forward direction fd indicated in FIG. 1-FIG. 3. Likewise, when the drive wheels 3 of the robotic lawnmower 1 are rotated at the same rotational velocity in a reverse rotational direction, and no wheel slip is occurring, the robotic lawnmower 1 will move in the reverse direction.

According to the illustrated embodiments, the robotic lawnmower 1 may be referred to as a four-wheeled rear wheel driven robotic lawnmower 1. According to further embodiments, the robotic lawnmower 1 may be provided with another number of wheels 3, 3′, such as three wheels. Moreover, according to further embodiments, the robotic lawnmower 1 may be provided with another configuration of driven and non-driven wheels, such as a front wheel drive or an all-wheel drive. Furthermore, the robotic lawnmower 1 may comprise another type of lawnmower support member than wheels, such as a number of ground followers, a continuous track assembly, or the like.

As schematically indicated in FIG. 1, according to the illustrated embodiments, the robotic lawnmower 1 comprises a control arrangement 21. The control arrangement 21 is configured to navigate the robotic lawnmower 1 over a ground surface 4. The control arrangement 21 may be configured to control propulsion of the robotic lawnmower 1, and steer the robotic lawnmower 1, by controlling electrical motors M of the robotic lawnmower 1 arranged to drive the drive wheels 3 of the robotic lawnmower 1.

According to further embodiments, the control arrangement 21 may be configured to steer the robotic lawnmower 1 by controlling the angle of steered wheels of the robotic lawnmower 1. According to still further embodiments, the robotic lawnmower may be an articulated robotic lawnmower, wherein the control arrangement 21 may be configured to steer the robotic lawnmower by controlling the angle between frame portions of the articulated robotic lawnmower.

The control arrangement 21 may be configured to control propulsion of the robotic lawnmower 1 and may be configured to steer the robotic lawnmower 1 so as to navigate the robotic lawnmower 1 in an area to be operated. The robotic lawnmower 1 may further comprise one or more sensors arranged to sense a magnetic field of a wire, and/or one or more positioning units, and/or one or more sensors arranged to detect an impending or ongoing collision event with an object.

In addition, the robotic lawnmower 1 may comprise a communication unit connected to the control arrangement 21. The communication unit may be configured to communicate with a remote communication unit to receive instructions therefrom and/or to send information thereto. The communication may be performed wirelessly over a wireless connection such as the internet, or a wireless local area network (WLAN), or a cellular network, or a wireless connection for exchanging data over short distances using short-wavelength, i.e. ultra-high frequency (UHF) radio waves in the industrial, scientific, and medical (ISM) band from 2.4 to 2.486 GHz.

As an alternative, or in addition, the control arrangement 21 may be configured to obtain data from, or may comprise, one or more positioning units utilizing a local reference source, such as a local sender and/or a wire, to estimate or verify a current position of the robotic lawnmower 1. As another example, the robotic lawnmower 1 may comprise one or more of a Radio Detection and Ranging (radar) sensor, a Light Detection and Ranging (lidar) sensor, an image capturing unit, such as a camera, an ultrasound sensor, or the like.

The control arrangement 21 may be configured to control propulsion of the robotic lawnmower 1, and steer the robotic lawnmower 1, so as to navigate the robotic lawnmower 1 in a systematic and/or random pattern to ensure that an area is completely covered, for example using input from one or more of the above described sensors and/or units. Furthermore, the robotic lawnmower 1 may comprise one or more batteries arranged to supply electricity to components of the robotic lawnmower 1. As an example, the one or more batteries may be arranged to supply electricity to electrical motors M of the robotic lawnmower 1, such as to one or more electric propulsion motors, by an amount controlled by the control arrangement 21.

As is best seen in FIG. 3, the robotic lawnmower 1 comprises a cutting unit 5. The cutting unit 5 is configured to cut vegetation, such as grass. According to the illustrated embodiments, the cutting unit 5 comprises a cutting disc and a number of cutting members pivotably arranged at a periphery of the cutting disc. Moreover, the robotic lawnmower 1 comprises a motor 32 arranged to rotate the cutting unit 5 around a rotation axis Ax during operation of the robotic lawnmower 1. According to the illustrated embodiments, the motor 32 is an electric motor.

According to further embodiments, the robotic lawnmower 1 may comprise another type of cutting unit 5 than depicted in FIG. 3, such as a cutting arm with sharp outer edges. Moreover, the robotic lawnmower 1 may comprise more than one cutting unit 5.

According to the illustrated embodiments, the robotic lawnmower 1 comprises a cutting guard 15. The cutting guard 15 surrounds at least part of the cutting unit 5 and is configured to prevent debris ejection and accidental blade contact. Moreover, the cutting guard 15 may be configured to enhance the mowing quality by helping in even grass cutting and directing grass clippings, either for collection or mulching.

FIG. 4 illustrates a top view of the robotic lawnmower 1 illustrated in FIG. 1-FIG. 3. In FIG. 4, the robotic lawnmower 1 is illustrated as seen straight towards the first plane P1. Moreover, in FIG. 4, the second plane P2 of FIG. 3 is schematically indicated. Below, simultaneous reference is made to FIG. 1-FIG. 4, if not indicated otherwise.

As can be seen in FIG. 1-FIG. 4, the robotic lawnmower 1 comprises an external guard 7. The external guard 7 encloses at least part of the cutting unit 5 and forms an outer protection configured to prevent objects, such as stones, stumps, or a limb of a person or animal from reaching the cutting unit 5. Moreover, as indicated in FIG. 1-FIG. 4, the external guard 7 comprises a bumper section 9.

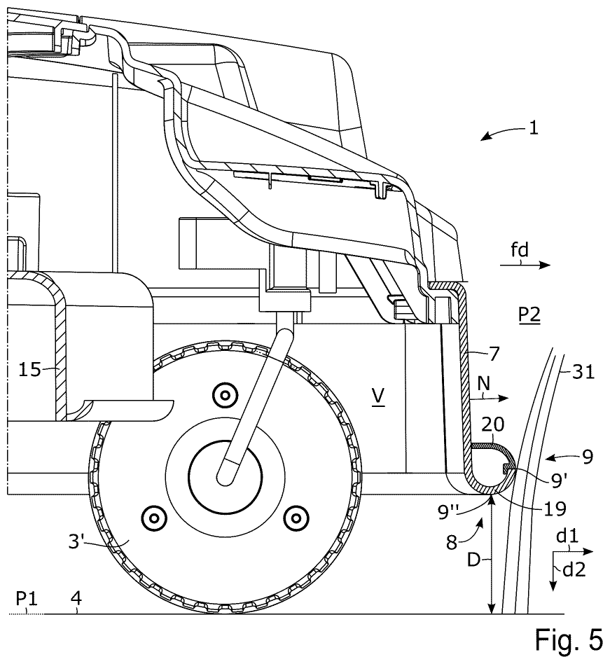

FIG. 5 illustrates an enlarged portion of the cross section of FIG. 3. Moreover, in FIG. 5, a number of grass straws 31 have been schematically illustrated to explain the working principle of the bumper section 9 of the robotic lawnmower 1 according to embodiments herein.

As indicated in FIG. 2-FIG. 5, the external guard 7 comprises an edge portion 8 which faces the first plane P1. In other words, the edge portion 8 faces a ground surface 4 when the robotic lawnmower 1 is positioned onto the ground surface 4 in an intended use position. According to the illustrated embodiments, the edge portion 8 is a trailing edge portion of the external guard 7.

As is best seen in FIG. 4, according to the illustrated embodiments, the bumper section 9 extends along the entire edge portion 8 of the external guard 7. In other words, according to the illustrated embodiments, the bumper section 9 extends along a front portion 8′ of the edge portion 8 as seen relative to the forward moving direction fd of the robotic lawnmower 1 as well as along a lateral side portion 8″ of the edge portion 8 as seen relative to the forward moving direction fd of the robotic lawnmower 1. A front portion 8′ and a lateral side portion 8″ of the edge portion 8 are indicated in FIG. 4. However, as is explained in greater detail below, according to further embodiments, the robotic lawnmower 1 may be configured differently and the bumper section 9 may extend along at least a portion of the edge portion 8 of the external guard 7.

As can be seen in FIG. 1-FIG. 5, the bumper section 9 protrudes out from the external guard 7. According to the illustrated embodiments, the bumper section 9 has a radius of curvature of 12 mm. According to further embodiments, the bumper section 9 may have a radius of curvature within the range of 5-40 mm, or within the range of 8-16 mm.

In more detail, according to the illustrated embodiments, the bumper section 9 has a radius of curvature 12 mm as measured in the second plane P2. The second plane P2 indicated in FIG. 5 is perpendicular to the first plane P1 and is parallel to a surface normal N of the external guard 7 at an intersection between the second plane P2 and the external guard 7.

According to the illustrated embodiments, the bumper section 9 has a constant radius of curvature along the extension around the edge portion 8 of the external guard 7. However, according to further embodiments, the bumper section 9 may have a varying radius of curvature along the extension around the edge portion 8 of the external guard 7.

As indicated above, the second plane P2 of FIG. 3 and FIG. 5 is also indicated in FIG. 4. Moreover, in FIG. 4, an alternative second plane P2′ is indicated. Since the bumper section 9 has a constant radius of curvature along the extension around the edge portion 8 of the external guard 7, the bumper section 9 has a radius of curvature of 12 mm also as measured in the alternative second plane P2′. Moreover, as indicated in FIG. 3, the alternative second plane P2′ is perpendicular to the first plane P1 and is parallel to a surface normal N′ of the external guard 7 at an intersection between the alternative second plane P2′ and the external guard 7. The alternative second plane P2′ may also be referred to as a further second plane, or a third plane.

According to the illustrated embodiments, the alternative second plane P2′ is parallel to the lateral direction 1a of the robotic lawnmower 1. In other words, according to the illustrated embodiments, the alternative second plane P2′ is perpendicular to the second plane P2. However, as understood from the above described, due to the design of the external guard 7, according to the illustrated embodiments, the bumper section 9 has a radius of curvature of 12 mm as measured also in other second planes, wherein the other second planes are parallel to a surface normal of the external guard 7 at an intersection between the other second plane and the external guard 7.

In FIG. 5, a first portion 9′ of the bumper section 9 is indicated. The first portion 9′ points/faces in a direction d1 parallel to the first plane P1. In other words, the first portion 9′ of the bumper section 9 has a surface normal parallel to the first plane P1. In FIG. 5, the first portion 9′ of the bumper section 9 is illustrated as being in abutting contact with one of the grass straws 31.

According to the illustrated embodiments, the bumper section 9 has a radius of curvature of 12 mm at the first portion 9′ of the bumper section 9. According to further embodiments, the bumper section 9 may have a radius of curvature within the range of 5-40 mm, or within the range of 8-16 mm, at the first portion 9′ of the bumper section 9. In this manner, the friction between the external guard 7 and the grass straws 31 can be significantly reduced, as is further explained in the following.

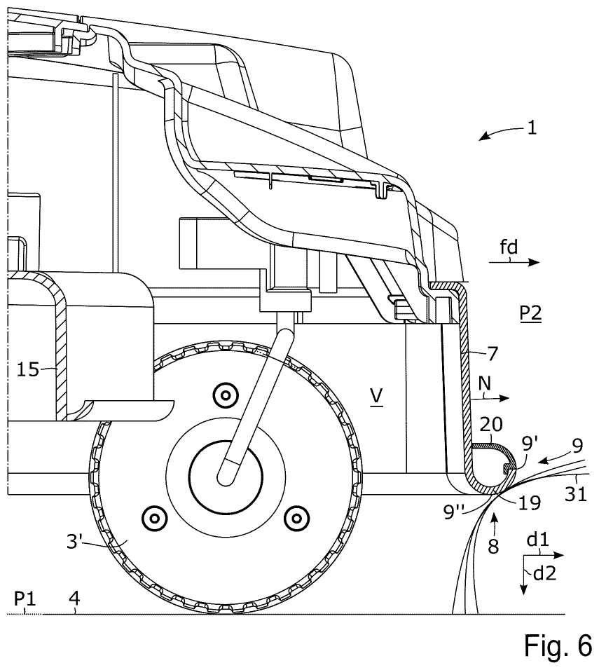

FIG. 6 illustrates the cross section of FIG. 5 in which the robotic lawnmower 1 has moved a distance in the forward moving direction fd of the robotic lawnmower 1 from the position illustrated in FIG. 5. Below, simultaneous reference is made to FIG. 1-FIG. 6, if not indicated otherwise.

In FIG. 5 and FIG. 6, a second portion 9″ of the bumper section 9 is indicated. The second portion 9″ of the bumper section 9 points/faces in a direction d2 towards the first plane P1. In other words, second portion 9″ of the bumper section 9 has a surface normal perpendicular to the first plane P1. According to the illustrated embodiments, the bumper section 9 has a radius of curvature of 12 mm at the second portion 9″ of the bumper section 9. According to further embodiments, the bumper section 9 may have a radius of curvature within the range of 5-40 mm, or within the range of 8-16 mm, at the second portion 9″ of the bumper section 9.

Due to these features, low friction between the external guard 7 and grass straws 31 can be ensured when the grass straws 31 reach the second portion 9″ of the bumper section 9 after first having been bent by the first portion 9′ of the bumper section 9.

Moreover, as can be seen in FIG. 5 and FIG. 6, according to the illustrated embodiments, the bumper section 9 has a constant radius of curvature along the full extension between the first and second portions 9′, 9″. In other words, according to the illustrated embodiments, the bumper section 9 has a radius of curvature of 12 mm along the full extension between the first and second portions 9′, 9″. However, according to further embodiments, the bumper section 9 may have a radius of curvature within the range of 5-40 mm, or within the range of 8-16 mm, along the full extension between the first and second portions 9′, 9″.

Furthermore, as can be seen in FIGS. 5 and 6, according to the illustrated embodiments, the bumper section 9 has a constant radius of curvature of 12 mm along approximately 75% of the circumference of the bumper section 9 as measured in the second plane P2. According to further embodiments, the bumper section 9 may have a radius of curvature within the range of 5-40 mm, or within the range of 8-16 mm, along more than 50% of the circumference of the bumper section 9 as measured in the second plane P2.

As is indicated in FIG. 5 and FIG. 6, according to the illustrated embodiments, a first part 19 of the bumper section 9 is formed by a curved portion of the external guard 7. The curved portion of the external guard 7 is curved in a direction out from a volume V enclosed by the external guard 7. In FIG. 5 and FIG. 6, a portion of the cutting guard 15 can be seen. As can be seen when comparing FIG. 5, FIG. 6 and FIG. 3, the cutting unit 5 and the cutting guard 15 are arranged inside the volume V enclosed by the external guard 7.

According to the illustrated embodiments, the bumper section 9 only protrudes in directions out from the volume V enclosed by the external guard 7. That is, as can be seen in FIG. 5 and FIG. 6, the external guard 7 comprises straight sections, i.e., non-curved sections, having surface normals N substantially parallel to the first plane P1, wherein the straight sections extend to the curved portions of the external guard 7 at the region of the second portion 9″ of the bumper section 9, and wherein the curved portions of the external guard 7 is curved in a direction out from the volume V enclosed by the external guard 7.

Moreover, as is indicated in FIG. 5 and FIG. 6, according to the illustrated embodiments, the bumper section 9 comprises a second part 20 attached to the first part 19. The second part 20 is also indicated in FIG. 1. According to the illustrated embodiments, the second part 20 is attached to the first part 19 using a number of screws. According to further embodiments, the second part 20 may be attached to the first part 19 using a number of other types of fastening elements, such as a number of bolts or rivets. Moreover, the second part 20 may be attached to the first part 19 in another manner than by using fastening elements, such as by gluing.

According to the illustrated embodiments, the first part 19 is arranged closer to the first plane P1 than the second part 20. Moreover, according to the illustrated embodiments, the interface between the first and second parts 19, 20 is positioned at the first portion 9′ of the bumper section 9 referred to above. Moreover, as clearly seen in FIG. 5 and FIG. 6, according to the illustrated embodiments, the first and second parts 19, 20 together form a hollow structure. The hollow structure results in an external guard 7 having conditions for a low weight, while being robust.

According to the illustrated embodiments, the bumper section 9 is configured such that the centre of curvature of the bumper section 9 in the second plane P2 is within the hollow structure. That is, according to the illustrated embodiments, the radius of curvature of the bumper section 9, as measured in the second plane P2, is measured from a point within the hollow structure formed by the first and second parts 19, 20 of the bumper section 9. However, according to further embodiments, the bumper section 9 may be configured differently.

In FIG. 5, the distance D between the first plane P1 and the second portion 9″ of the bumper section 9 is indicated. According to the illustrated embodiments, the distance D between the first plane P1 and the second portion 9″ of the bumper section 9 is 70 mm. In other words, according to the illustrated embodiments, the distance D between the second portion 9″ of the bumper section 9 and a flat ground surface 4 is 70 mm when the robotic lawnmower 1 is positioned on the flat ground surface 4 in the intended use position thereon. According to further embodiments, the distance D between the first plane P1 and the second portion 9″ of the bumper section 9 may be within the range of 60-80 mm, or may be within the range of 65-75 mm.

As understood from the above described, due to the features of the external guard 7, conditions are provided for reduced friction between the external guard 7 and grass moving towards the external guard 7. That is, the fact that the bumper section 9 extends along at least a portion of the edge portion 8, and the bumper section 9 protrudes out from the external guard 7 and has a radius of curvature within the range of 5-40 mm, ensures low frictional properties between the external guard 7 and grass partially because grass straws 31 of the grass can be bent in a smoother manner upon reaching the edge portion 8 of the external guard 7.

Since conditions are provided for reduced friction between the external guard 7 of the robotic lawnmower 1 and grass, a robotic lawnmower 1 is provided having conditions for a reduced energy consumption. As a further result, conditions are provided for an increased available operational time of the robotic lawnmower 1 before an energy storing unit of the robotic lawnmower 1 has to be charged or refilled. Moreover, the robotic lawnmower 1 can be operated in a more cost-efficient and environmentally friendly manner.

In addition, since conditions are provided for reduced friction between the external guard 7 of the robotic lawnmower 1 and grass, the robotic lawnmower 1 has conditions for operating areas having considerable grass heights, such as a grass height exceeding 130 mm, with a lowered risk of slipping of drive wheels 3 while navigating through such areas.

As schematically indicated in FIG. 1, according to the illustrated embodiments, the robotic lawnmower 1 comprises a sensor assembly 23. The sensor assembly 23 is configured to detect occurrences of impacts between the robotic lawnmower 1 and external objects. According to the illustrated embodiments, the sensor assembly 23 comprises an accelerometer configured to detect occurrences of impacts between the robotic lawnmower 1 and external objects by monitoring the acceleration of the robotic lawnmower 1. However, according to further embodiments, the sensor assembly 23, as referred to herein, may comprise another type of sensors, such as one or more sensors configured to sense a relative movement between the bumper section 9 and the lawnmower body 30 of the robotic lawnmower 1.

According to the illustrated embodiments, the control arrangement 21 is configured to stop movement of the robotic lawnmower 1 when the sensor assembly 23 is detecting an impact between the robotic lawnmower 1 and an external object. The control arrangement 21 may be configured to stop movement of the robotic lawnmower 1 by cancelling propulsion in a current movement direction of the robotic lawnmower 1 when the sensor assembly 23 is detecting an impact between the robotic lawnmower 1 and an external object and may then initiate propulsion in another direction.

Since the external guard 7 of the robotic lawnmower 1 is capable of reducing friction against grass, a robotic lawnmower 1 is provided having conditions for a reduced likelihood of obtaining false collision detection signals from the sensor assembly 23, for example when moving across areas having considerable grass heights.

As explained above, according to the illustrated embodiments, the bumper section 9 extends along the entire edge portion 8 of the external guard 7. However, according to some embodiments of the present disclosure, the robotic lawnmower 1 may comprise a bumper section 9, as referred to herein, extending solely along the front portion 8′ of the edge portion 8 as seen relative to the forward moving direction fd of the robotic lawnmower 1.

Moreover, according to some embodiments of the present disclosure, the robotic lawnmower 1 may comprise bumper sections 9, as referred to herein, extending solely along a respective a lateral side portion 8″ of the edge portion 8 as seen relative to the forward moving direction fd of the robotic lawnmower 1. According to such embodiments, the front portion of the external guard may comprise a comb-like array of elements, such as bars or rods, arranged at the edge portion of the external guard. According to some of these embodiments, each element of such array of elements may have a radius of curvature within the range of 5-40 mm, or within the range of 8-16 mm. In this manner, low friction can be obtained between the external guard and grass upon movement of the robotic lawnmower in the forward moving direction thereof also in such embodiments.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A self-propelled robotic lawnmower comprising:
a number of lawnmower support members configured to abut against a ground surface in a first plane during operation of the robotic lawnmower,
a cutting unit, and
an external guard enclosing at least part of the cutting unit,
wherein the external guard comprises an edge portion facing the first plane and a bumper section extending along at least a portion of the edge portion,
and wherein the bumper section protrudes out from the external guard and has a radius of curvature within a range of 5-40 mm.

2. The robotic lawnmower according to claim 1, wherein the bumper section has a radius of curvature within the range of 5-40 mm as measured in a second plane, and wherein the second plane is perpendicular to the first plane and is parallel to a surface normal of the external guard at an intersection between the second plane and the external guard.

3. The robotic lawnmower according to claim 1, wherein the bumper section has a radius of curvature within the range of 5-40 mm at a first portion of the bumper section, and wherein the first portion points in a direction parallel to the first plane.

4. The robotic lawnmower according to claim 1, wherein the bumper section has a radius of curvature within the range of 5-40 mm at a second portion of the bumper section, and wherein the second portion points in a direction towards the first plane.

5. The robotic lawnmower according to claim 3, wherein the bumper section has a radius of curvature within the range of 5-40 mm along the full extension between the first and second portions.

6. The robotic lawnmower according to claim 1, wherein a distance between the first plane and a second portion of the bumper section, pointing in a direction towards the first plane, is within the range of 60-80 mm.

7. The robotic lawnmower according to claim 1, wherein the bumper section has a radius of curvature within the range of 5-40 mm along more than 50% of a circumference of the bumper section.

8. The robotic lawnmower according to claim 1, wherein the bumper section extends along a front portion of the edge portion as seen relative to a forward moving direction of the robotic lawnmower.

9. The robotic lawnmower according to claim 1, wherein the bumper section extends along a lateral side portion of the edge portion as seen relative to a forward moving direction of the robotic lawnmower.

10. The robotic lawnmower according to claim 1, wherein at least a first part of the bumper section is formed by a curved portion of the external guard.

11. The robotic lawnmower according to claim 10, wherein the bumper section comprises a second part attached to the first part.

12. The robotic lawnmower according to claim 11, wherein the first part is arranged closer to the first plane than the second part.

13. The robotic lawnmower according to claim 11, wherein the first and second parts together form a hollow structure.

14. The robotic lawnmower according to claim 1, wherein bumper section only protrudes in directions out from a volume enclosed by the external guard.

15. The robotic lawnmower according to claim 1, wherein the robotic lawnmower comprises a control arrangement configured to navigate the robotic lawnmower over the ground surface.

16. The robotic lawnmower according to claim 15, wherein the robotic lawnmower comprises a sensor assembly configured to detect occurrences of impacts between the robotic lawnmower and external objects, and wherein the control arrangement is configured to stop movement of the robotic lawnmower when the sensor assembly is detecting an impact between the robotic lawnmower and an external object.
